(19) United States
(12) Patent Application Publication
(10) Pub. No.: US 2025/0223663 A1
(43) Pub. Date: Jul. 10, 2025

(54) NON-ORIENTED ELECTRICAL STEEL SHEET AND MANUFACTURING METHOD THEREFOR

(71) Applicant: Hyundai Steel Company, Incheon (KR)

(72) Inventors: Seong Hyeon Yoo, Incheon (KR); Chun Ku Kang, Incheon (KR)

(21) Appl. No.: 19/093,394

(22) Filed: Mar. 28, 2025

Related U.S. Application Data
(63) Continuation of application No. PCT/KR2023/011067, filed on Jul. 28, 2023.

(30) Foreign Application Priority Data
Sep. 30, 2022 (KR) 10-2022-0125792

(51) Int. Cl. C21D 9/46; C21D 6/00; C21D 8/12; C22C 38/00; C22C 38/02; C22C 38/04; C22C 38/06; C22C 38/14; H01F 1/147

(52) U.S. Cl. CPC C21D 9/46; C21D 6/008; C21D 8/1222; C21D 8/1233; C21D 8/1261; C22C 38/001; C22C 38/002; C22C 38/02; C22C 38/04; C22C 38/06; C22C 38/14; H01F 1/14775; C22C 2202/02

(57) ABSTRACT

In an aspect, a method of manufacturing a non-oriented electrical steel sheet is provided, the method including hot rolling a slab including, by weight %, carbon (C) greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities; preliminarily annealing the hot-rolled sheet; cold rolling the preliminarily annealed hot-rolled sheet; and cold annealing the cold-rolled sheet, wherein the cold annealing includes a first heating stage, a second heating stage, and a soaking stage, the cold-rolled sheet is heated from a start temperature to a recrystallization temperature at a first average heating rate in the first heating stage, and the cold-rolled sheet is heated from the recrystallization temperature to a target temperature at a second average heating rate faster than the first average heating rate in the second heating stage.

### CROSS-REFERENCE TO RELATED APPLICATIONS

This application is a continuation of International Application No. PCT/KR2023/011067 filed on Jul. 28, 2023, which claims under 35 U.S.C. § 119 (a) the benefit of Korean Patent Application No. 10-2022-0125792 filed on Sep. 30, 2022, the entire contents of which applications are incorporated by reference herein.

### FIELD

The present disclosure relates to a non-oriented electrical steel sheet and a method of manufacturing the same.

### BACKGROUND

Recently, there has been an increasing demand for environmental preservation and energy efficiency improvement. In particular, the transition from internal combustion engine vehicles to electric vehicles or hybrid vehicles has been accelerating.

Non-oriented electrical steel sheets are materials with uniform magnetic properties in all directions regardless of the direction of rolling and are used to reduce iron loss and increase the magnetic flux density for energy efficiency.

A process of manufacturing non-oriented electrical steel sheets varies with the content of silicon (Si). Thus, when the content of silicon (Si) exceeds 2.0 wt %, brittleness may increase and fracture may occur during cold rolling. Therefore, an annealing and picking line (APL) process is essential before the final cold rolling.

### SUMMARY

Embodiments of the present disclosure may manufacture a non-oriented electrical steel sheet with improved magnetic properties by controlling a heating rate in a cold annealing step.

An embodiment of the present disclosure provides a method of manufacturing a non-oriented electrical steel sheet, the method including hot rolling a slab including, by weight %, carbon (C): greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities; preliminarily annealing the hot-rolled sheet; cold rolling the preliminarily annealed hot-rolled sheet; and cold annealing the cold-rolled sheet, wherein the cold annealing includes a first heating stage, a second heating stage, and a soaking stage, the cold-rolled sheet is heated from a start temperature to a recrystallization temperature at a first average heating rate in the first heating stage, and the cold-rolled sheet is heated from the recrystallization temperature to a target temperature at a second average heating rate faster than the first average heating rate in the second heating stage.

In the present embodiment, the first average heating rate may be for example greater than 5° C./s and less than 20° C./s.

In the present embodiment, the second average heating rate may be for example 15° C./s or more and 30° C./s or less.

In the present embodiment, the recrystallization temperature may be for example 750° C. to 800° C.

In the present embodiment, the target temperature may be for example 850° C. to 1,050° C.

In the present embodiment, the cold annealing suitably may further include a cooling stage, and a cold-rolled annealed sheet may be cooled at a cooling rate of for example 30° C./s or more in the cooling stage.

In the present embodiment, a <111>//ND orientation fraction of a texture of the non-oriented electrical steel sheet suitably may be 30% or less.

In the present embodiment, a <100>//ND orientation fraction of a texture of the non-oriented electrical steel sheet suitably may be 20% or more.

In the present embodiment, an average grain size of the non-oriented electrical steel sheet suitably may be 100 μm or more and 130 μm or less.

Another embodiment of the present disclosure provides a non-oriented electrical steel sheet including or comprising, by weight %, carbon (C): greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities, wherein a <111>//ND orientation fraction of a texture is 30% or less and a <100>/ND orientation fraction of the texture is 20% or more.

In the present embodiment, the non-oriented electrical steel sheet may have an iron loss of 13.0 W/kg or less (with respect to W10/400) and a magnetic flux density of 1.68 T or more (with respect to B50).

In the present embodiment, the non-oriented electrical steel sheet may have a yield strength (YP) of 400 MPa or more and a tensile strength (TS) of 500 MPa or more.

Other aspects, features, and advantages of the present disclosure will become more apparent from the detailed description, the claims, and the drawings for implementing the present disclosure.

According to an embodiment of the present disclosure as described above, the non-oriented electrical steel sheet with improved magnetic properties may be manufactured by controlling a heating rate in a cold annealing step. The scope of the present disclosure is not limited by these effects.

As referred to herein, yield strength (YP) and tensile stress (TS) and elongation (EL) can be measured using a commercially available tensile tester and according to the ISO standard ISO 6892-1, published in October 2009.

A <111>//ND orientation fraction {111}//ND and <100>/ND orientation fraction for a material or composition as referred to herein can be determined by known methods including via markings and with imaging or other visualization of the material or composition.

The magnetic flux density is mostly evaluated as B50. B50 indicates the magnetic flux density at 5000 A/m.

### BRIEF DESCRIPTION OF DRAWINGS

FIG. 1 is a flowchart schematically illustrating a method of manufacturing a non-oriented electrical steel sheet according to an embodiment of the present disclosure.

FIG. 2 is a diagram illustrating a phase according to silicon (Si) composition.

FIG. 3 is a diagram illustrating magnetization speeds of a texture according to orientations.

FIG. 4 is a diagram illustrating hysteresis loops in a <100> orientation and a <111> orientation.

FIG. 5 is a diagram illustrating a magnetic flux density according to a texture orientation.

FIGS. 6A to 6G are photographs obtained by observing a microstructure according to a heat treatment temperature using electron backscatter diffraction (EBSD).

### DETAILED DESCRIPTION

As the present disclosure allows for various changes and numerous embodiments, certain embodiments will be illustrated in the drawings and described in the detailed description. Effects and features of the present disclosure, and methods for achieving them will be clarified with reference to embodiments described below in detail with reference to the drawings. However, the present disclosure is not limited to the following embodiments and may be embodied in various forms.

Although the terms “first,” “second,” etc. may be used to describe various elements, these elements should not be limited by these terms. These terms are only used to distinguish one element from another.

As used herein, the singular forms “a,” “an,” and “the” are intended to include the plural forms as well, unless the context clearly indicates otherwise.

It will be further understood that the terms “comprises” or “comprising” used herein specify the presence of stated features or components, but do not preclude the presence or addition of one or more other features or components.

It will be further understood that, when a layer, region, or component is referred to as being “on” another layer, region, or component, it may be directly on the other layer, region, or component, or may be indirectly on the other layer, region, or component with intervening layers, regions, or components therebetween.

Sizes of components in the drawings may be exaggerated or reduced for convenience of explanation. For example, sizes and thicknesses of elements in the drawings are arbitrarily illustrated for convenience of explanation, and thus the present disclosure is not limited thereto.

“A and/or B” is used herein to select only A, select only B, or select both A and B. Also, “at least one of A and B” is used herein to select only A, select only B, or select both A and B.

In the following embodiment, the meaning that a wiring “extends in a first direction or a second direction” includes not only extending in a linear shape, but also extending in a zigzag or a curved shape in the first direction or the second direction.

In the following embodiments, “a plan view of an object” refers to “a view of an object seen from above, and “a cross-stageal view of an object” refers to “a view of an object vertically cut and seen from the side. In the following embodiments, when elements “overlap,” it may mean that the elements overlap in a “plan view” and a “cross-stageal view”.

Hereinafter, embodiments of the present disclosure will be described in detail with reference to the accompanying drawings, wherein the same or corresponding elements are denoted by the same reference numerals throughout.

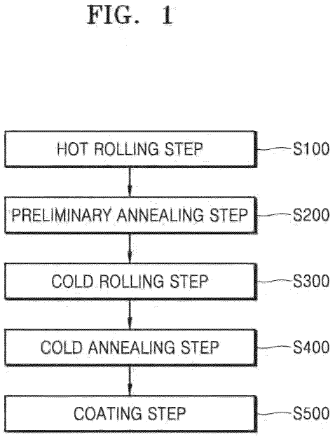

FIG. 1 is a flowchart schematically illustrating a method of manufacturing a non-oriented electrical steel sheet according to an embodiment of the present disclosure.

Referring to FIG. 1, the method of manufacturing the non-oriented electrical steel sheet according to an embodiment may include a hot rolling step (S100), a preliminary annealing step (S200), a cold rolling step (S300), a cold annealing step (S400), and a coating step (S500).

In the method of manufacturing the non-oriented electrical steel sheet according to an embodiment of the present disclosure, a semi-finished product to be hot-rolled may be a slab. The slab in a semi-finished state may be secured through a continuous casting process after obtaining molten steel of a certain composition through a steel making process.

In an embodiment, the slab may include, by weight %, carbon (C): greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities.

Carbon (C) may be a component that increases an iron loss by forming a carbide such as TiC or NbC. In an embodiment, carbon (C) may be included in an amount greater than 0% to 0.005% or less by weight % with respect to the total weight of the slab. When carbon (C) is included in the amount greater than 0.005% with respect to the total weight of the slab, magnetic properties of the manufactured non-oriented electrical steel sheet may be degraded by causing magnetic aging. When carbon (C) is included in the amount greater than 0% to 0.005% or less by weight % with respect to the total weight of the slab, a magnetic aging phenomenon may be suppressed.

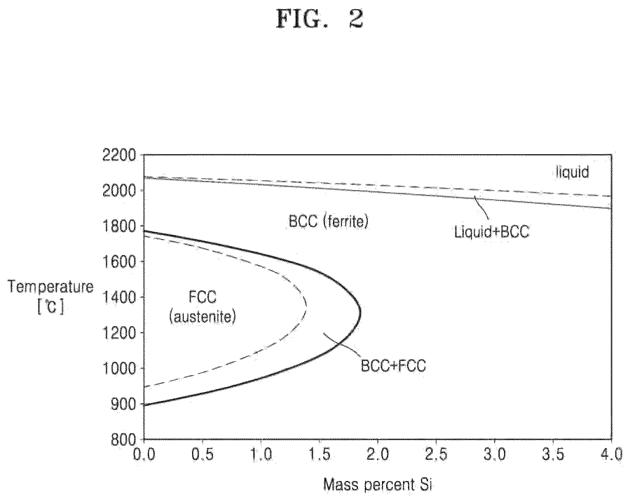

FIG. 2 is a diagram illustrating a phase according to a composition of silicon (Si).

As shown in FIG. 2, when the content of silicon (Si) is 2.0 wt % or more, a ferrite single phase may be present in all regions without a phase transformation. On the other hand, when the content of silicon (Si) is less than 2.0 wt %, an austenite stage is present in some regions, and thus a phase transformation may occur during heat treatment at a target temperature of about 950° C. to be described below. At this time, when a phase transformation occurs during a heat treatment process, a texture orientation distribution changes, and thus it may be preferable that the content of silicon (Si) is limited to a composition range without a phase transformation.

Silicon (Si) may be a component that decreases eddy current loss by increasing resistivity. In an embodiment, silicon (Si) may be included in an amount of 2.0% or more to 4.0% or less by weight % with respect to the total weight of a slab. When silicon (Si) is included in an amount less than 2.0% with respect to the total weight of the slab, it may be difficult to obtain a low iron loss value. On the other hand, as the content of silicon (Si) included in the slab increases, an investment rate and a magnetic flux density may decrease. In addition, when silicon (Si) is included in an amount greater than 4.0% with respect to the total weight of the slab, brittleness increases and cold rolling property decreases, which may degrade productivity.

Manganese (Mn) may be a component that increases resistivity together with silicon (Si) and improves the texture. In an embodiment, manganese (Mn) may be included in an amount of 0.1% or more to 0.5% or less by weight % with respect to the total weight of the slab. When manganese (Mn) is included in an amount less than 0.1% with respect to the total weight of the slab, a fine MnS precipitate may be formed to suppress grain growth. On the other hand, when manganese (Mn) is included in an amount greater than 0.5% with respect to the total weight of the slab, a coarse MnS precipitate may be formed to degrade magnetic properties such as a reduction in the magnetic flux density. When manganese (Mn) is included in an amount of 0.1% or more to 0.5% or less by weight % with respect to the total weight of the slab, a microstructure and a texture in the slab (or a non-oriented electrical steel sheet) may be controlled.

Aluminum (Al) may be a component that increases resistivity together with silicon (Si) and decreases eddy current loss. In addition, aluminum (Al) may reduce magnetic anisotropy and thus reduce a magnetic deviation. In an embodiment, aluminum (Al) may be included in an amount of 0.9% or more to 1.5% or less by weight % with respect to the total weight of the slab. When aluminum (Al) is included in an amount less than 0.9% with respect to the total weight of the slab, it may be difficult to obtain a low iron loss value. In addition, the magnetic property deviation may be increased by forming a fine nitride. On the other hand, when aluminum (Al) is included in an amount greater than 1.5% with respect to the total weight of the slab, cold rolling properties may degrade, and nitride may be excessively formed to reduce the magnetic flux density, which may degrade magnetic properties.

Phosphorus (P) which is a grain boundary segregation element may be a component that develops a texture. In an embodiment, phosphorus (P) may be included in an amount greater than 0% to 0.015% or less by weight % with respect to the total weight of the slab. When phosphorus (P) is included in an amount greater than 0.015% with respect to the total weight of the slab, grain growth may be suppressed due to a segregation effect, magnetic properties may degrade, and cold rolling property may degrade.

Sulfur(S) may increase an iron loss and suppress grain growth by forming a precipitate such as MnS and CuS. In an embodiment, sulfur (S) may be included in an amount greater than 0% to 0.005% or less by weight % with respect to the total weight of the slab. When sulfur (S) is included in an amount greater than 0.005% with respect to the total weight of the slab, a precipitate such as MnS and CuS is formed, which may increase an iron loss and suppress grain growth.

Nitrogen (N) may increase an iron loss and suppress grain growth by forming a precipitate such as AlN, TiN, or NbN. In an embodiment, nitrogen (N) may be included in an amount greater than 0% to 0.005% or less by weight % with respect to the total weight of the slab. When nitrogen (N) is included in an amount greater than 0.005% with respect to the total weight of the slab, a precipitate such as AlN, TiN, or NbN is formed, which may increase an iron loss and suppress grain growth.

Titanium (Ti) may suppress grain growth by forming a precipitate such as TiC and TiN. In an embodiment, titanium (Ti) may be included in an amount greater than 0% to 0.005% or less by weight % with respect to the total weight of the slab. When titanium (Ti) is included in an amount greater than 0.005% with respect to the total weight of the slab, a precipitate such as TiC and TiN may be formed, which may deteriorate magnetic properties.

In the hot rolling step (S100), a hot-rolled sheet may be obtained by reheating the slab and then, hot-rolling the reheated slab. First, in the hot rolling step (S100), the slab may be reheated. When the slab heating temperature is too high, a precipitate such as C, S, or N in the slab is reused to form fine precipitates in a subsequent rolling and annealing step, which may suppress grain growth and deteriorate magnetic properties. On the other hand, when the slab heating temperature is too low, rolling load may increase during hot rolling, which may decrease the rolling property. In an embodiment, the slab reheating temperature in the hot rolling step (S100) may be about 1,000° C. to about 1,200° C.

In addition, in the hot rolling step (S100), the reheated slab may be rolled at a certain finishing delivery temperature (FDT). In an embodiment, the FDT of the hot rolling stage (S100) may be about 860° C. to about 900° C.

In addition, in aspects, in the hot rolling step (S100), the hot-rolled sheet may be cooled to a certain coiling temperature (CT) and coiled. In an embodiment, the CT suitably may be about 550° C. to about 650° C.

In an embodiment, a thickness of the hot-rolled sheet suitably may be about 1.8 mm to about 2.6 mm after hot rolling. At this time, when the thickness of the hot-rolled sheet exceeds about 2.6 mm, a cold rolling reduction rate increases, which may deteriorate the texture.

The preliminary annealing step (S200) suitably may be performed after the hot rolling step (S100). In the preliminary annealing step (S200), the coiled and cooled hot-rolled sheet may be preliminarily annealed. At this time, in aspects, the preliminarily annealed hot-rolled sheet may be referred to as a hot-rolled annealed sheet. Uniformity and cold rolling property of a microstructure of the hot-rolled sheet may be secured through the preliminary annealing step (S200).

In aspects, the preliminary annealing step (S200) suitably may be performed at an elevated annealing temperature such as about 950° C. to about 1,100° C., suitably a holding time of about 30 seconds to about 120 seconds, and suitably a heating rate of about 20° C./s or more. At this time, when the annealing temperature of the preliminary annealing step (S200) is too low, fine inclusions such as a carbide and a nitride can be formed from a surface layer, and the inclusions do not sufficiently grow, which may deteriorate the magnetic properties of a final product. On the other hand, when the annealing temperature of the preliminary annealing step (S200) is too high, not only inclusions distribution but also grains can excessively grow, resulting in a large grain size deviation and a large amount of oxidation, which may adversely affect the final product.

In the preliminary annealing step (S200), in aspects, the hot-rolled annealed sheet suitably may be cooled at a cooling rate of about 30° C./s. At this time, the hot-rolled annealed sheet suitably may be cooled to about 200° C. to about 250° C. In addition, in aspects, an oxide layer formed on the surface of the hot-rolled annealed sheet suitably may be removed, for example, using an acid cleaning solution after the preliminary annealing step (S200).

The cold rolling step (S300) suitably may be performed after the preliminary annealing step (S200). In the cold rolling step (S300), the hot-rolled annealed sheet may be cold-rolled. At this time, the cold-rolled hot-rolled annealed sheet may be called a cold-rolled sheet. In the cold rolling step (S300), the hot-rolled annealed sheet on which may have had oxide removal (such as having acid cleaning performed) may be cold-rolled to a suitable thickness such as about 0.35 mm or less. At this time, hot rolling suitably may be performed by raising a sheet temperature (e.g., the temperature of the hot-rolled annealed sheet) for example to about 150° C. to about 200° C. in order to provide rolling properties. A final reduction rate in the cold rolling step (S300) may be about 80% to about 85%.

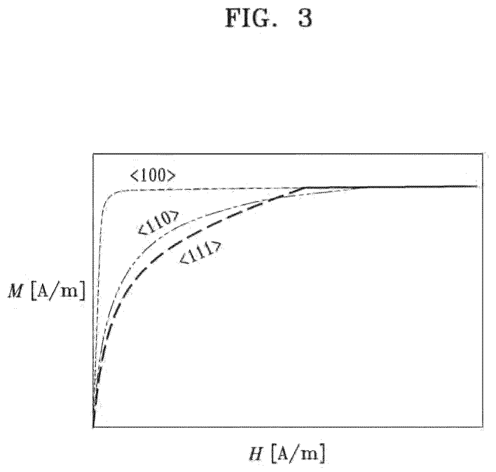

FIG. 3 is a diagram illustrating magnetization speeds of a texture according to orientations. Specifically, FIG. 3 is a diagram illustrating magnetization speeds in a <100> orientation, a <110> orientation, and a <111> orientation.

Referring to FIG. 3, it may be seen that the magnetization speed of the <100> orientation is the fastest among the <100> orientation, the <110> orientation, and the <111> orientation. That is, it may be seen that magnetization of the <100> orientation is the easiest among the <100> orientation, the <110> orientation, and the <111> orientation. Therefore, it may be seen that the <100> orientation among the <100> orientation and the <111> orientation is advantageous for magnetic properties compared to the <111> orientation.

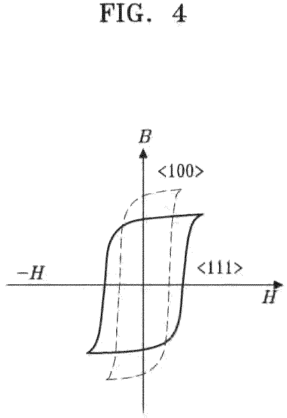

FIG. 4 is a diagram illustrating hysteresis loops in a <100> orientation and a <111> orientation.

In FIG. 4, the area surrounded by the hysteresis loops represents the energy loss per unit volume. That is, the larger the area surrounded by the hysteresis loop, the greater the energy loss per unit volume.

Referring to FIG. 4, it may be seen that the area of the hysteresis loop in the <100> orientation is smaller than the area of the hysteresis loop in the <111> orientation. That is, it may be seen that the <100> orientation has lower an iron loss and higher magnetic flux density than the <111> orientation.

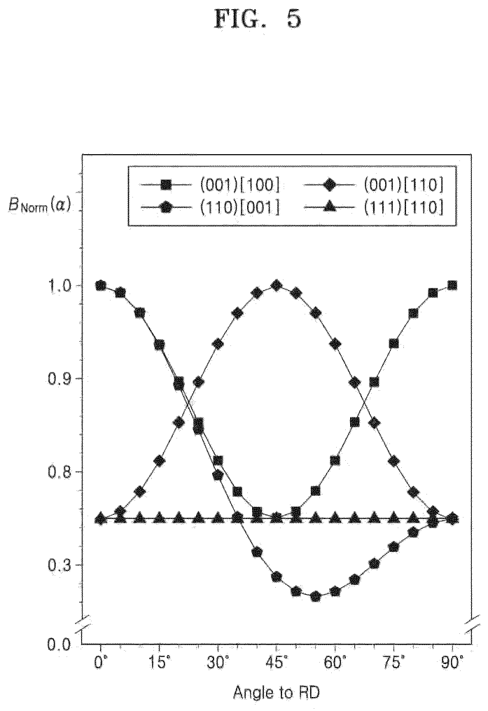

FIG. 5 is a diagram illustrating a magnetic flux density according to the orientation of a texture.

Referring to FIG. 5, it may be seen that the average magnetic flux density of a <111> orientation is the lowest and the average magnetic flux density of a <100> orientation is the highest. Therefore, when the <100> orientation increases in the texture, the magnetic flux density of the non-oriented electrical steel sheet including the same may increase.

In general, when a cold-rolled sheet that has undergone cold-rolling is heat-treated, the microstructure of a cold-rolled annealed sheet (or final annealed sheet) may be formed through recovery, recrystallization, and growth processes. In addition, during heat treatment near a recrystallization temperature, nucleation and growth for recovery and recrystallization occur. In the heat treatment process, a heating rate may affect recovery/nucleation/recrystallization processes.

Because the accumulated deformation energy is different for each location, recrystallization and growth may occur first in a region with high deformation energy when the heating rate is fast, a large amount of <111>/ND orientation may be formed, and a region with low deformation energy may be relatively delayed and dissipated in a growth stage.

The texture after the final cold rolling may include two orientations of α-fiber and γ-fiber, and during heat treatment in the cold annealing step (S400), nucleation and recrystallization may be performed first at a γ-fiber location with relatively high deformation energy when passing through a recrystallization temperature stage. At this time, grains of the <111>//ND orientation that are unfavorable to magnetic properties are formed at the location, and the first formed texture of the <111>//ND orientation tries to grow first in the growth stage after the recrystallization. Therefore, the <111>//ND orientation appears strongly in the texture of the final cold-rolled annealed sheet, which may cause deterioration of an iron loss and magnetic flux density.

On the other hand, when the heating rate decreases, recovery and recrystallization may occur evenly in all regions, and as a result, the <100>//ND orientation and the <111>//ND orientation may compete and grow.

Therefore, the orientation of the texture may be controlled by determining a time at which the recrystallization is completed and controlling the heating rate before the recrystallization temperature is reached.

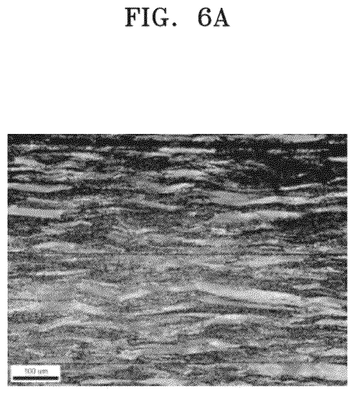

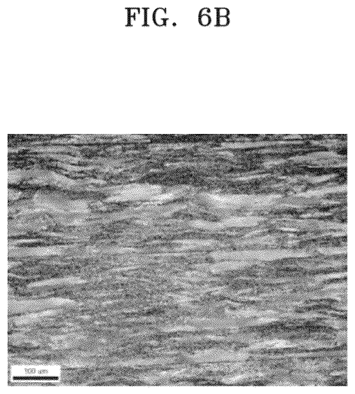

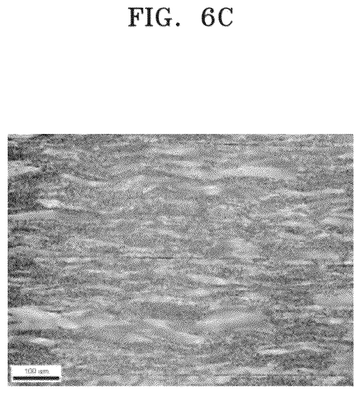

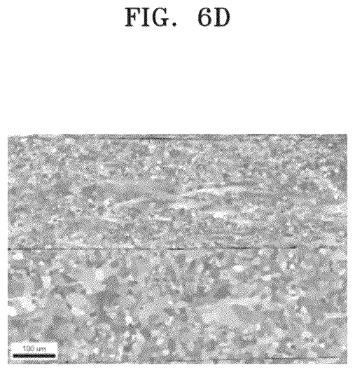

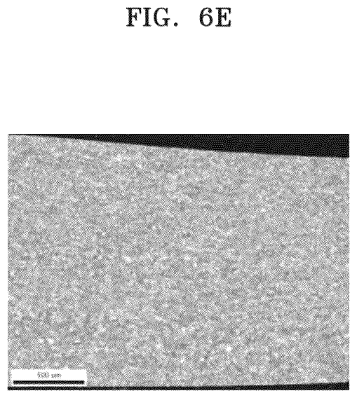

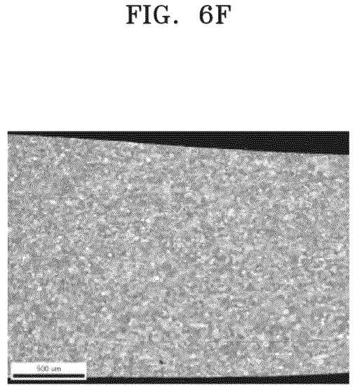

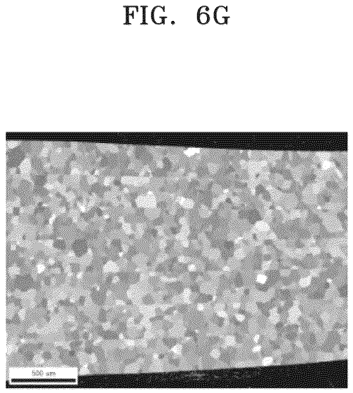

FIGS. 6A to 6G are photographs obtained by observing a microstructure according to a heat treatment temperature using electron backscatter diffraction (EBSD). Specifically, FIG. 6A is a photograph of the microstructure observed using the EBSD when the heat treatment temperature is 600° C., FIG. 6B is a photograph of the microstructure observed using the EBSD when the heat treatment temperature is 650° C., FIG. 6C is a photograph of the microstructure observed using the EBSD when the heat treatment temperature is 700° C., FIG. 6D is an EBSD photograph of micro-tissues when the heat treatment temperature is 750° C., FIG. 6E is a photograph of the microstructure observed using the EBSD when the heat treatment temperature is 800° C., FIG. 6F is a photograph of the microstructure observed using the EBSD when the heat treatment temperature is 850° C., and FIG. 6G is a photograph of the microstructure observed using the EBSD when the heat treatment temperature is 950° C.

Referring to FIG. 6A to FIG. 6G, when a cold-rolled sheet that has undergone cold-rolling is heat-treated, it may be seen that recrystallization is completed at about 800° C.

Therefore, the orientation of a texture may be controlled by controlling a heating rate at about 800° C. or less.

After the cold rolling step (S300), the cold annealing step (S400) may be performed. In the cold annealing step (S400), the cold-rolled sheet may be annealed. At this time, the annealed cold-rolled sheet may be called an annealed cold sheet.

In an embodiment, the cold annealing step (S400) suitably may include a heating stage, a soaking stage, and a cooling stage. Also, in certain aspects, the heating stage suitably may include a first heating stage and a second heating stage. That is, the cold annealing step (S400) may include the first heating stage, the second heating stage, the soaking stage, and the cooling stage. At this time, the heating stage refers to a stage where the cold-rolled sheet is heated so that the temperature of the cold-rolled sheet increases, the soaking stage refers to a stage where the cold-rolled sheet is soaked and heated at a target temperature, and the cooling stage refers to a stage where the soaked and heated cold-rolled sheet is cooled.

In an embodiment, the cold-rolled sheet may be heated in the heating stage of the cold annealing step (S400). At this time, the heating stage may include the first heating stage and the second heating stage. That is, the heating stage may be divided into the first heating stage and the second heating stage. The first heating stage and the second heating stage may have different average heating rates.

In an embodiment, the cold-rolled sheet may be heated (or heated) from a start temperature to a recrystallization temperature at a first average heating rate in the first heating stage. The start temperature may be room temperature. For example, the start temperature suitably may be about 15° C. to about 25° C. The recrystallization temperature may be a temperature at which the recrystallization of a texture in the cold-rolled sheet is completed. For example, the recrystallization temperature suitably may be about 750° C. to about 800° C. However, the present disclosure is not limited thereto.

Also, the first average heating rate suitably may be greater than about 5° C./s and less than about 20° C./s. More preferably, the first average heating rate suitably may be greater than about 10° C./s and less than about 15° C./s. When the first average heating rate is about 5° C./s or less, grains may be excessively grown due to the low heating rate, which may increase eddy current loss and result in insignificant improvement of magnetic properties. In addition, as the heat treatment time increases, productivity and process cost may increase. On the other hand, when the first average heating rate is about 20° C./s or more, the heating rate to the recrystallization temperature is too high (e.g., fast) and primary recrystallization is formed finely and a texture of the <111>//ND orientation is formed and grown first, thereby increasing a <111>//ND fraction, resulting in an increase in an iron loss and a decrease in magnetic flux density.

Therefore, when the first average heating rate is greater than about 5° C./s and less than about 20° C./s (or, from 5° C./s to 20° C./s), the non-oriented electrical steel sheet with excellent magnetic properties may be manufactured. Specifically, the heating rate below a temperature at which recrystallization of a microstructure is completed is greater than about 5° C./s and less than about 20° C./s, so that the <100>//ND orientation and the <111>/ND orientation may compete to grow, thereby increasing the fraction of the <100>//ND orientation in the texture, and thus the non-oriented electrical steel sheet manufactured through this may have low iron loss and high magnetic flux density.

In an embodiment, the cold-rolled sheet heated (or heated) through the first heating stage may be heated (or heated) from the recrystallization temperature to the target temperature at the second average heating rate in the second heating stage. As described above, the recrystallization temperature may be a temperature at which the recrystallization of the texture in the cold-rolled sheet is completed. For example, the recrystallization temperature suitably may be about 750° C. to about 800° C. However, the present disclosure is not limited thereto.

In an embodiment, the target temperature, which is a temperature at which the heated (or heated) cold-rolled sheet is soaked and heated (or annealed), suitably may be about 850° C. to about 1,050° C. When the target temperature in the cold annealing step (S400) is too low, the grain size is fine, which may increase hysteresis loss. On the other hand, when the target temperature in the cold annealing step (S400) is too high, the grain size increases too much, which may increase the eddy current loss.

In an embodiment, the second average heating rate may be greater than the first average heating rate. That is, the average heating rate of the second heating stage may be faster than the average heating rate of the first heating stage. A second average heating rate suitably may be about 15° C./s to about 30° C./s. More preferably, the second average heating rate may exceed a first average heating rate, but suitably may be about 30° C./s or less. When the second average heating rate is equal to or less than the first average heating rate, productivity and process cost may increase as the heat treatment time increases. On the other hand, when the second average heating rate exceeds about 30° C./s, the <111>//ND fraction may increase, and as a result, an iron loss may increase, and magnetic flux density may decrease. This will be described in more detail below.

Therefore, when the second average heating rate is 15° C./s or more and about 30° C./s or less, the non-oriented electrical steel sheet with excellent magnetic properties may be manufactured.

In an embodiment, a target temperature maintenance time suitably may be about 40 seconds to about 200 seconds. However, the present disclosure is not limited thereto. For example, the total time for performing the cold annealing step (S400) suitably may be about 40 seconds to about 200 seconds.

Thereafter, in the cooling stage, the cold-rolled annealed sheet suitably may be cooled for example at a cooling rate of about 30° C./s or more. At this time, in aspects, the cold-rolled annealed sheet suitably may be cooled to about 200° C. to about 250° C.

In an embodiment, the cold annealing step (S400) suitably may be performed under a mixture atmosphere condition of nitrogen and hydrogen. Specifically, the cold annealing step (S400) suitably may be performed in a gas atmosphere including for example about 5% to about 40% by volume of hydrogen and balance nitrogen.

After the cold annealing step (S400), the coating step (S500) may be performed. In the coating step (S500), a coating layer suitably may be formed on the cold-rolled annealed sheet. The coated layer is formed through the coating stage (S500), and thus, punching property may be improved, and insulation property may be ensured.

The non-oriented electrical steel sheet manufactured through the method of manufacturing the non-oriented electrical steel sheet according to an embodiment of the present disclosure may have an average grain size of about 100 μm to about 130 μm. The manufactured non-oriented electrical steel sheet may have an iron loss (with respect to W10/400) of about 13.0 W/kg or less and a magnetic flux density (with respect to B50) of about 1.68 T or more. In addition, the manufactured non-oriented electrical steel sheet may have a yield strength (YP) of about 400 MPa or more and a tensile strength (TS) of about 500 MPa or more.

### Experimental Example

Hereinafter, the present disclosure will be described in more detail through the experimental example. However, the following experimental example is intended to explain the present disclosure in more detail, and the scope of the present disclosure is not limited by the following experimental example. The following experimental example may be appropriately modified and changed by one of ordinary skill in the art within the 5 scope of the present disclosure.

TABLE 1

| | C | Si | Mn | Al | P | S | N | Ti |
|---|---|---|---|---|---|---|---|---|
| | (weight | (weight | (weight | (weight | (weight | (weight | (weight | (weight |
| Classification | %) | %) | %) | %) | %) | %) | %) | %) |
| Slab | 0.0018% | 3.3% | 0.25% | 1.2% | 0.0053% | 0.0020% | 0.0018% | 0.0021% |
| composition | | | | | | | | |

TABLE 2

| | Thickness | Cold | First | Second |
|---|---|---|---|---|
| | of cold- | annealing | average | average |
| | rolled | Target | heating | heating |
| | sheet | temperature | rate | rate |
| Classification | (mm) | (° C.) | (° C./s) | (° C./s) |
| Embodiment 1 | 0.25 | 950 | 10 | 20 |
| Embodiment 2 | 0.25 | 950 | 15 | 20 |
| Comparative | 0.25 | 950 | 5 | 20 |
| Example 1 | | | | |
| Comparative | 0.25 | 950 | 20 | 20 |
| Example 2 | | | | |
| Comparative | 0.25 | 950 | 30 | 20 |
| Example 3 | | | | |

Table 1 is a slab composition table including main components and impurities. Embodiment 1, Embodiment 2, Comparative Example 1, Comparative Example 2, and Comparative Example 3 have been all manufactured using the slab of Table 1.

Referring to Table 1 and Table 2, a hot-rolled sheet with a thickness of about 2.0 mm was manufactured by heating the slab including the component composition shown in Table 1 at about 1,150° C. and hot rolling the slab at about 890° C. of FDT and about 610° C. of CT. Thereafter, the hot-rolled sheet was preliminarily annealed at 1,050° C. for 60 seconds and then acid-cleaned. Thereafter, a cold-rolled sheet with a thickness of about 0.25 mm was formed by cold rolling the hot-rolled annealed sheet, and cold annealing was performed at the first average heating rate, the second average heating rate, and the target temperature shown in Table 2. At this time, the target temperature maintenance time was about 30 seconds, the cooling rate was 30° C./s, and cold annealing was performed in a mixture atmosphere of 30% of hydrogen and 70% of nitrogen.

TABLE 3

| | | <111>// | <100>// | | Magnetic |
|---|---|---|---|---|---|
| | | ND | ND | Iron | flux |
| | Grain | orientation | orientation | loss | density |
| Classifica- | size | fraction | fraction | W10/400 | B50 |
| tion | (μm) | (Area %) | (Area %) | (W/kg) | (T) |
| Embodiment 1 | 123 | 26.3 | 21.0 | 12.232 | 1.685 |
| Embodiment 2 | 117 | 29.7 | 20.6 | 12.556 | 1.681 |
| Comparative | 140 | 25.0 | 21.2 | 12.240 | 1.683 |
| Example 1 | | | | | |
| Comparative | 109 | 33.2 | 17.6 | 13.140 | 1.663 |
| Example 2 | | | | | |
| Comparative | 93 | 35.5 | 16.3 | 13.359 | 1.657 |
| Example 3 | | | | | |

Table 3 is a table illustrating grain sizes, <111>//ND orientation fraction (area %), <100>//ND orientation fraction (area %), iron loss, and magnetic flux density measurement results of Embodiment 1, Embodiment 2, and Comparative Examples 1 to 3. The grain sizes, <111>//ND orientation fraction, and <100>//ND orientation fraction may be measured using EBSD, and measured data may be obtained using TSLOIM analysis software. However, the present disclosure is not limited thereto. For magnetic measurement, an iron loss value and a magnetic flux density value were calculated as average values after measuring in L and C directions through a single sheet tester (SST). In Table 3, B50 is the magnetic flux density at 5000 A/m, and W10/400 is an iron loss at a frequency of 400 Hz and magnetic flux density of 1.0 Tesla.

Referring to Table 2 and Table 3, it may be seen that the slower the first average heating rate in the first heating stage of the cold annealing step S400, the <111>//orientation fraction decreases and the <100>/ND orientation fraction increases. However, when the first average heating rate in the first heating stage of the cold annealing step (S400) is too small, grains may be excessively grown, and a heat treatment time increases due to the low heating rate, which may reduce productivity and increase process costs.

In addition, in the case of Embodiment 1 and Embodiment 2, it may be seen that the grain sizes are 123 μm and 117 μm, respectively, which satisfy about 100 μm or more and about 130 μm or less. In the case of Embodiment 1 and Embodiment 2, it may be seen that the <111>//ND orientation fraction of the texture is 30% or less, and the <100>//ND orientation fraction of the texture is 20% or more. In addition, in the case of Embodiment 1 and Embodiment 2, it may be seen that an iron loss is 13.0 W/kg or less and the magnetic flux density is 1.68 T or more.

When the first average heating rate is greater than 5° C./s and less than 20° C./s, it may be seen that the grain sizes, the <111>//ND orientation fraction of the texture, the <100>/ND orientation fraction of the texture, iron loss, and magnetic flux density satisfy the desired conditions.

Specifically, when the first average heating rate satisfies a range greater than 5° C./s and less than 20° C./s, the grain sizes may satisfy a range of about 100 μm or more and about 130 μm or less, the <111>/ND orientation fraction of the texture may decrease and the <100>/ND orientation fraction of the texture may increase. As previously reviewed, because the <100>//ND orientation of the texture is excellent compared to the <111>//ND orientation, when the first average heating rate is more than 5° C./s and less than 20° C./s, the <111>//ND orientation fraction of the texture decreases and the <100>/ND orientation fraction of the texture increases, and thus, an iron loss of the manufactured non-oriented electrical steel sheet may be reduced and the magnetic flux density thereof may be improved.

However, in the case of Comparative Example 1, the first average heating rate is performed at 5° C./s, and thus grains may be excessively grown due to the low heating rate, and the heat treatment time increases due to the low heating rate, which may reduce productivity and increase process costs.

In addition, in the case of Comparative Example 2 and Comparative Example 3, it may be seen that the first average heating rate is more than 20° C./s, the <111>//ND orientation fraction is large, the <100>/ND orientation fraction of the texture is low, the iron loss is high, and the magnetic flux density is low.

Therefore, when the first average heating rate of the first heating stage of the cold annealing step (S400) satisfies a range more than about 5° C./s and less than about 20° C./s, and more preferably, greater than about 10° C./s and less than about 15° C./s, the manufactured non-oriented electrical steel sheet may have an iron loss of about 13.0 W/kg or less (with respect to W10/400) and magnetic flux density of about 1.68T or more (with respect to B50). That is, when the first average heating rate in the first heating stage of the cold annealing step (S400) satisfies a range greater than about 5° C./s and less than about 20° C./s, the non-oriented electrical steel sheet with excellent magnetic properties may be manufactured.

While the present disclosure has been particularly shown and described with reference to embodiments thereof, they are provided for the purposes of illustration and it will be understood by one of ordinary skill in the art that various modifications and equivalent other embodiments made be made from the present disclosure. Accordingly, the true technical scope of the present disclosure is defined by the technical spirit of the appended claims.

1: A method of manufacturing of a non-oriented electrical steel sheet, the method comprising:
hot rolling a slab comprising, by weight %, carbon (C) greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities;
preliminarily annealing the hot-rolled sheet;
cold rolling the preliminarily annealed hot-rolled sheet; and
cold annealing the cold-rolled sheet;
wherein the cold annealing comprises a first heating stage, a second heating stage, and a soaking stage,
the cold-rolled sheet is heated from a start temperature to a recrystallization temperature at a first average heating rate in the first heating stage, and
the cold-rolled sheet is heated from the recrystallization temperature to a target temperature at a second average heating rate faster than the first average heating rate in the second heating stage.

2: The method of claim 1, wherein
the first average heating rate is greater than 5° C./s and less than 20° C./s.

3: The method of claim 2, wherein
the second average heating rate is 15° C./s or more and 30° C./s or less.

4: The method of claim 1, wherein
the recrystallization temperature is 750° C. to 800° C.

5: The method of claim 1, wherein
the target temperature is 850° C. to 1,050° C.

6: The method of claim 1, wherein
the cold annealing further includes a cooling stage, and
the cold-rolled annealed sheet is cooled at a cooling rate of 30° C./s or more in the cooling stage.

7: The method of claim 1, wherein
a <111>//ND orientation fraction of a texture of the non-oriented electrical steel sheet is 30% or less.

8: The method of claim 1, wherein
a <100>//ND orientation fraction of a texture of the non-oriented electrical steel sheet is 20% or more.

9: The method of claim 1, wherein
an average grain size of the non-oriented electrical steel sheet is 100 μm or more and 130 μm or less.

10: A non-oriented electrical steel sheet comprising:
by weight %, carbon (C) greater than 0% to 0.005% or less, silicon (Si): 2.0% or more to 4.0% or less, manganese (Mn): 0.1% or more to 0.5% or less, aluminum (Al): 0.9% or more to 1.5% or less, phosphorus (P): greater than 0% to 0.015% or less, sulfur (S): greater than 0% to 0.005% or less, nitrogen (N): greater than 0% to 0.005% or less, titanium (Ti): greater than 0% to 0.005% or less, a balance being iron (Fe), and inevitable impurities,
wherein a <111>//ND orientation fraction of a texture is 30% or less and a <100>/ND orientation fraction of the texture is 20% or more.

11: The non-oriented electrical steel sheet of claim 10, wherein
the non-oriented electrical steel sheet has an iron loss of 13.0 W/kg or less (with respect to W10/400) and a magnetic flux density of 1.68 T or more (with respect to B50).

12: The non-oriented electrical steel sheet of claim 10, wherein
the non-oriented electrical steel sheet has a yield strength (YP) of 400 MPa or more and a tensile strength (TS) of 500 MPa or more.
